(19) United States
(12) Patent Application Publication
(10) Pub. No.: US 2004/0032324 A1
(43) Pub. Date: Feb. 19, 2004

(54) Brake light controller

(75) Inventor: Shigeko Otani, Fremont, CA (US)

Correspondence Address: BEYER WEAVER & THOMAS LLP, P.O. BOX 778, BERKELEY, CA, 94704-0778, US

(73) Assignee: OMRON Corporation

(21) Appl. No.: 10/219,448

(22) Filed: Aug. 14, 2002

(51) Int. Cl. B60Q 1/50

(52) U.S. Cl. 340/467

(57) ABSTRACT

An apparatus for controlling illumination of a brake light of a vehicle. The apparatus includes a controller, which is operable to control illumination of the brake light based on a low-pass filtered acceleration of the vehicle.

### BACKGROUND OF THE INVENTION

The present invention relates generally to a brake light controller. More specifically, the invention relates to mechanisms for controlling illumination of a brake light of a vehicle.

Vehicles including automobiles use various types of safety lights. These safety lights include headlights, brake lights, back-up lights, turn signals, and hazard warning lights. Brake lights are important as a vehicle driver estimates the speed of the vehicle in front of the driver based partially on the illumination of the leading vehicle's brake lights.

According to a conventional brake light control method, brake lights are illuminated only when a brake pedal is stepped on. Specifically, the brake lights are controlled based on a signal from a switch mechanically coupled to the brake pedal. As a result, the brake lights may be turned on even when the driver inadvertently steps on the brake pedal for a very short period of time. In such a case, the driver following the vehicle may mistakenly think that the vehicle in front of him is reducing speed, when this may not be the case. Conventional brake light controllers may thus provide following drivers with an unnecessary and confusing warning.

What is needed is an improved brake light controller for illuminating a brake light, capable of eliminating unnecessary intermittent illumination of the brake light.

### SUMMARY OF THE INVENTION

The present invention addresses these needs described above by low-pass filtering acceleration of a vehicle for controlling illumination of a brake light of the vehicle. For example, an apparatus for controlling illumination of a brake light of a vehicle includes a controller operable to control illumination of the brake light based on a low-pass filtered acceleration of the vehicle.

According to a specific embodiment of the present invention, an apparatus for controlling illumination of a brake light of a vehicle includes a controller which is operable to receive an acceleration signal corresponding to the acceleration of the vehicle, and perform low-pass filtering of the acceleration. In a further specific embodiment, the controller is operable to receive a speed signal corresponding to a speed of the vehicle, and modify a time constant of the low-pass filtering based on the speed signal. In still further specific embodiment, the controller is operable to set the time constant to a first constant when the speed is larger than a threshold speed, and set the time constant to a second constant when the speed is smaller than the threshold speed, where the first constant is substantially smaller than the second constant.

In an alternative embodiment, the controller is operable to integrate the acceleration signal over an integral interval, thereby performing the low-pass filtering of the acceleration. In a further specific embodiment, the controller is operable to receive a speed signal corresponding to a speed of the vehicle, and modify the integral interval based on the speed signal.

In another embodiment, a vehicle includes the apparatus for controlling illumination of a brake light of a vehicle described in the foregoing paragraphs.

In still another embodiment, a controller for controlling illumination of a brake light of a vehicle based on a detected acceleration is arranged to receive an acceleration signal corresponding to the acceleration of the vehicle; perform low-pass filtering of the acceleration, thereby generating a low-pass filtered signal; and control the illumination of the brake light based at least on the low-pass filtered signal. In a further specific embodiment, the controller is operable to integrate the acceleration signal over an integral interval, thereby performing the low-pass filtering of the acceleration.

A further understanding of the nature and advantages of the present invention may be realized by reference to the remaining portions of the specification and the drawings.

### BRIEF DESCRIPTION OF THE DRAWING

The invention, together with further objects and advantages thereof, may best be understood by reference to the following description taken in conjunction with the accompanying drawings in which:

FIG. 1 is a block diagram of a brake light controller according to an embodiment of the present invention;

FIG. 2 is a graph showing a relationship between the speed of the vehicle and the time constant used for the low-pass filtering operation according to one embodiment of the invention;

FIG. 3 is a graph showing a relationship between the speed of the vehicle and the time constant used for the low-pass filtering operation according to another embodiment of the invention;

FIG. 4 is a graph showing the acceleration of the vehicle, the low-pass filtered acceleration, and the illumination of the brake light according to one embodiment of the invention shown in FIG. 1; and

FIG. 5 is a block diagram of a method for controlling illumination of a brake light according to one embodiment of the present invention shown in FIG. 1.

### DETAILED DESCRIPTION OF SPECIFIC EMBODIMENTS

Various embodiments of the present invention will now be described in detail with reference to the drawings, wherein like elements are referred to with like reference labels throughout.

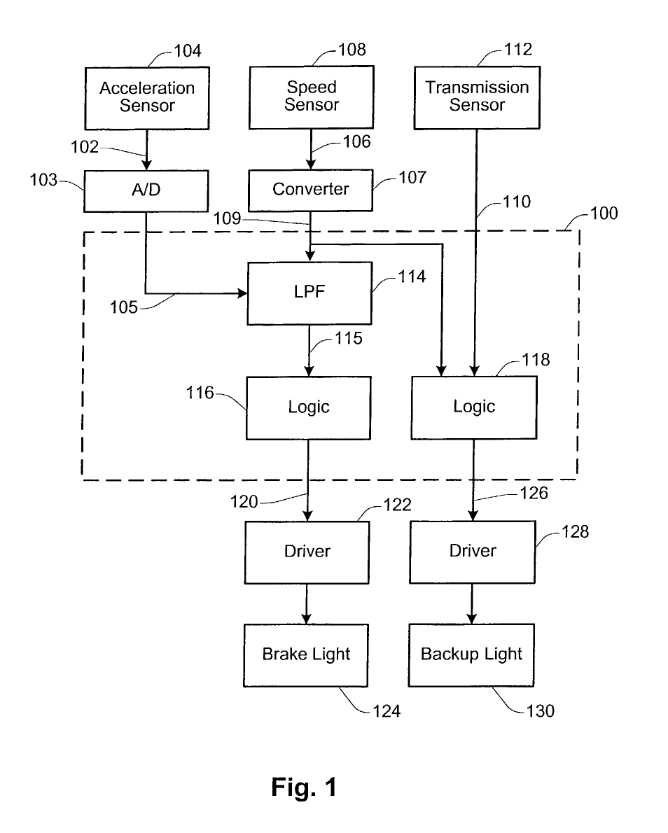

FIG. 1 is a block diagram of a brake light controller 100 according to an embodiment of the present invention. The brake light controller 100 is typically provided on a vehicle, such as an automobile, a motorcycle, or the like. Such a vehicle may include, for example, a body, wheels rotatably provided on the body, an engine or motor for actuating a shaft of the wheels, an accelerator for controlling the engine, a brake for braking the wheels, a transmission for changing the rotational speed of the shaft of the wheels, at least one brake light, and at least one backup light along with a brake light controller according to the present invention. However, the present invention may be utilized for other vehicles which do not have every element described above.

The brake light controller 100 receives an acceleration signal 102 from an acceleration sensor 104, a speed signal 106 from a speed sensor 108, and a transmission signal 110 from a transmission sensor 112. The brake light controller 100 includes a low-pass filter (“LPF”) 114, and logic circuitry 116 for controlling illumination of a brake light 124 via a driver 122. In this specific embodiment, the brake light controller 100 further includes logic circuitry 118 for controlling illumination of a backup light 130 via a driver 128. In some embodiments, however, the logic circuitry 118 may be omitted.

The acceleration sensor 104 detects acceleration of the vehicle, and outputs the acceleration signal 102 corresponding to the acceleration of the vehicle. Examples of the acceleration sensor 104 include an accelerometer. The acceleration signal 102 is typically an analog signal. However, the acceleration signal 102 may be a digital signal corresponding to the acceleration. The acceleration sensor 104 may be any suitable sensor which converts the acceleration of the vehicle to an electric signal. The acceleration sensor 104 may include, for example, a piezoelectric or piezoresistance device for generating an electric signal corresponding to the acceleration of the vehicle.

An analog-to-digital (“A/D”) converter 103 receives the acceleration signal 102 which is typically an analog signal, and generates a digital signal 105 corresponding to the analog acceleration signal 102. The digital signal 105 may be any suitable digitally coded signal corresponding to the acceleration of the vehicle. The digital signal 105 may represent, for example, an 8-bit word corresponding to the acceleration. If voltage level of the acceleration signal 102 is too small for A/D conversion, the A/D converter 103 may include an amplifying function to boost the level of the signal 102 up to a suitable level for A/D conversion.

In the specific embodiment shown in FIG. 1, the A/D converter 103 is provided near the acceleration sensor 104 and outside of the brake light controller 100. However, the A/D converter 103 may be provided within the brake light controller 100. When the acceleration sensor 104 itself is capable of generating a digital signal corresponding to the acceleration of the vehicle, the A/D converter 103 may be omitted.

The speed sensor 108 detects speed of the vehicle, and generates the speed signal 106 corresponding to the speed of the vehicle. In some embodiments, the speed signal 106 is a digital signal. In other embodiments, however, the speed signal 106 may be an analog signal corresponding to the acceleration. The speed sensor 108 may be any suitable sensor to convert the speed of the vehicle to an electric signal. For example, the speed sensor 108 may be optically, magnetically, or mechanically coupled to an output shaft of a transmission of an automobile, or one of the wheels of a vehicle, and is capable of outputting a signal corresponding to the number of rotations of the shaft or the wheel. Thus, the speed signal 106 represents the speed of the vehicle.

A converter 107 receives the speed signal 106, and generates a digital signal 109 corresponding to the speed signal 106. By way of example, the speed sensor 108 may be an optical sensor which outputs a pulse signal. In such a case, the number of the pulses per time unit corresponds to the speed of the vehicle. The converter 107 counts the number of the pulses in a time unit of the speed signal 106, and generates the digital signal 109. The digital signal 109 may be any suitable digitally coded signal corresponding to the speed of the vehicle. The digital signal 109 may represent, for example, an 8-bit word corresponding to the acceleration. When voltage level of the speed signal 106 is too small for conversion, the converter 107 may include an amplifying function to boost the level of the signal 106 up to a suitable level.

In the specific embodiment shown in FIG. 1, the converter 107 is provided near the speed sensor 108 and outside of the brake light controller 100. However, the converter 107 may be provided within the brake light controller 100. When the speed sensor 108 itself is capable of generating a digital signal corresponding to the speed of the vehicle, the converter 107 may be omitted.

The transmission sensor 112 detects whether the transmission of the vehicle is in the reverse mode, and outputs the transmission signal 110 corresponding to the state of the transmission of the vehicle, i.e., whether the transmission is in the reverse mode. The transmission signal 110 is typically a digital signal. The transmission sensor 112 may be any suitable sensor or switch which converts the state of the transmission of the vehicle to an electric signal. For example, the transmission sensor 112 may be optically, magnetically, or mechanically coupled to the transmission system of the vehicle. Thus, the transmission signal 110 represents whether the transmission is in the reverse mode.

The brake light controller 100 receives the signals 105, 109, and 110, and controls illumination of the brake light 124, and the backup light 130 based on the signals 105, 109, and 110. In summary, the brake light controller 100 turns on the brake light 124 when a modified value of the acceleration of the vehicle is substantially smaller than zero. The LPF 114 contributes to this modification of the originally detected acceleration of the vehicle.

The LPF 114 receives the signals 105, and 109 corresponding to the acceleration, and the speed, respectively, and generates a low-pass filtered signal 115 which represents a low-pass filtered acceleration of the vehicle based on the signals 105 and 109. The LPF 114 may be any suitable circuitry which is capable of performing a low-pass filtering operation on the acceleration of the vehicle which is represented by the signal 105. For example, the LPF 114 may be implemented by hardware, software, or a combination thereof. A hardware device implementing the LPF 114 may include a digital signal processor capable of performing a digital low-pass filtering operation.

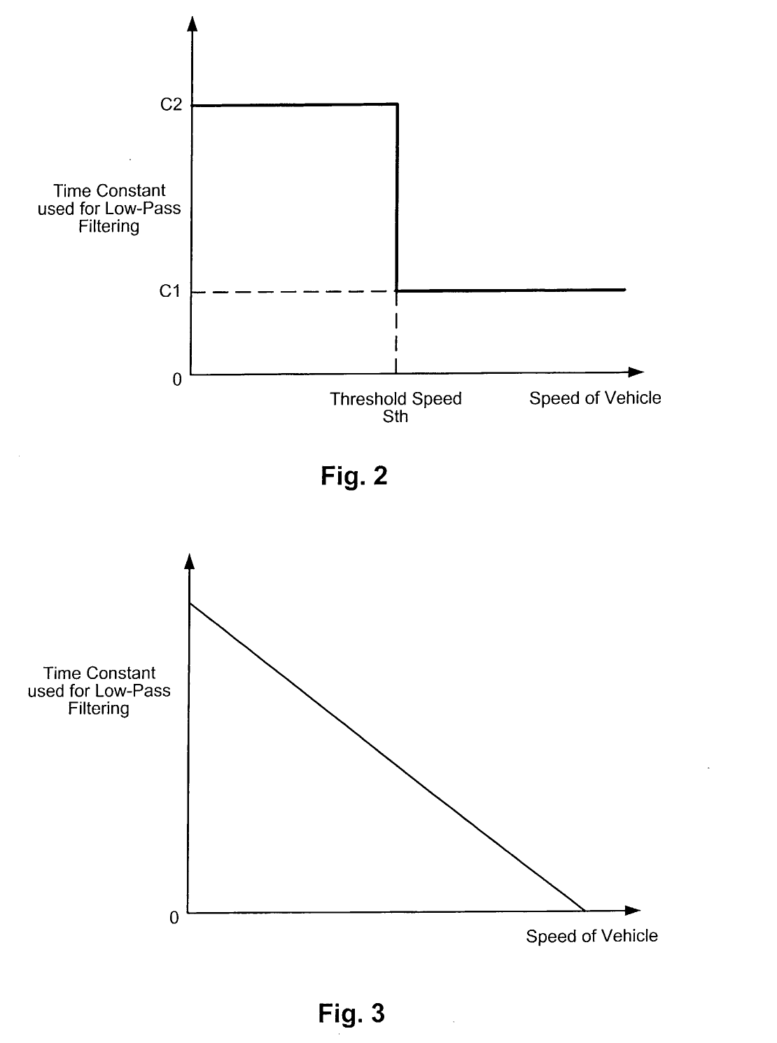

In the specific embodiment shown in FIG. 1, the LPF 114 modifies a time constant for the low-pass filtering operation based on the signal 109, which represents the speed of the vehicle. FIG. 2 is a graph showing a relationship between the speed of the vehicle and the time constant used for the low-pass filtering operation according to one embodiment of the invention. When the speed of the vehicle is larger than a threshold speed Sth, the LPF 114 uses a time constant C1 for the low-pass filtering operation of the acceleration of the vehicle. Conversely, when the speed of the vehicle is smaller than the threshold speed Sth, the LPF 114 uses a time constant C2 which is larger than the time constant C1 for the low-pass filtering operation of the acceleration. This modification of the time constant for the low-pass filtering operation based on the speed may be advantageous when it would be desirable that a high-speed vehicle turn on the brake light with higher responsiveness to the deceleration of the vehicle, and that a low-speed vehicle turn on the brake light with less responsiveness to the deceleration.

In this specific embodiment, the time constant for the low-pass filtering by the LPF 114 is modified to one of two different values, i.e., time constants C1 and C2. However, it should be appreciated that one of more than two time constants may be utilized based on the speed of the vehicle. For example, one of time constants C1-Cn (n=an integer more than 2) is selected for low-pass filtering based on the vehicle speed.

Further, in still another embodiment, the time constant used for the low-pass filtering may be substantially continuously varied based on the vehicle speed. FIG. 3 is a graph showing a relationship between the speed of the vehicle and the time constant used for the low-pass filtering operation according to another embodiment of the invention. According to the embodiment of FIG. 3, the time constant for the low-pass filtering by the LPF 114 is continuously varied based on the vehicle speed.

The LPF 114 outputs the low-pass filtered signal 115 to the logic circuitry 116. The signal 115 may be analog or digital as long as it represents the low-pass filtered acceleration of the vehicle. The logic circuitry 116 is capable of determining whether the low-pass filtered acceleration represented by the signal 115 is substantially smaller than zero. In this specification, the acceleration is larger than zero when the vehicle is increasing its speed. Conversely, the acceleration is smaller than zero when the vehicle is reducing its speed. However, in some embodiments, the polarity of each signal may be changed as long as each functional block in the brake light controller 100 correctly interprets the meaning of each signal representing a vehicle parameter.

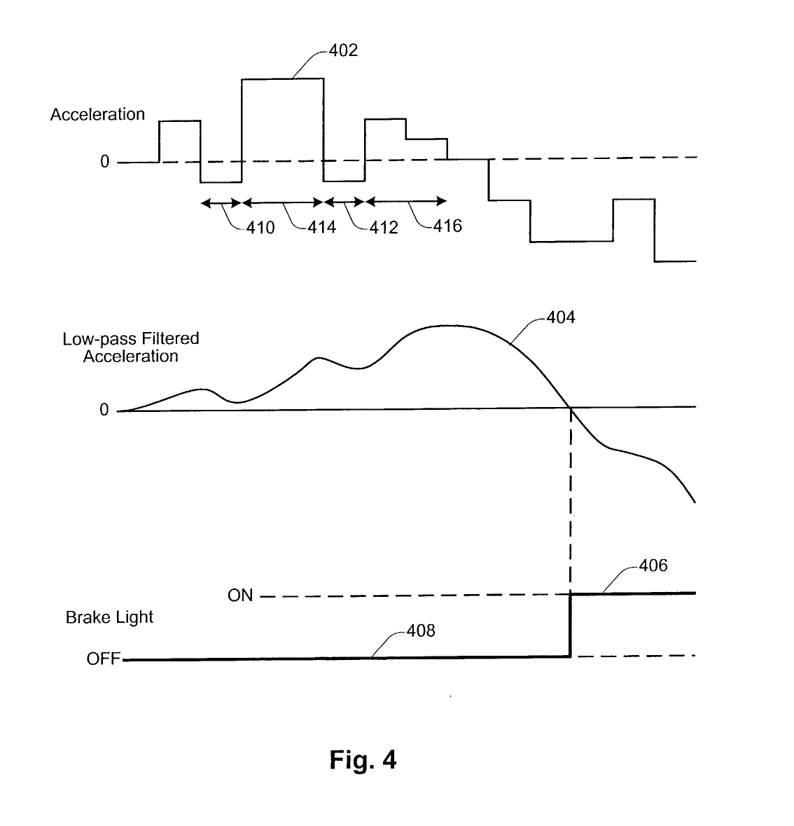

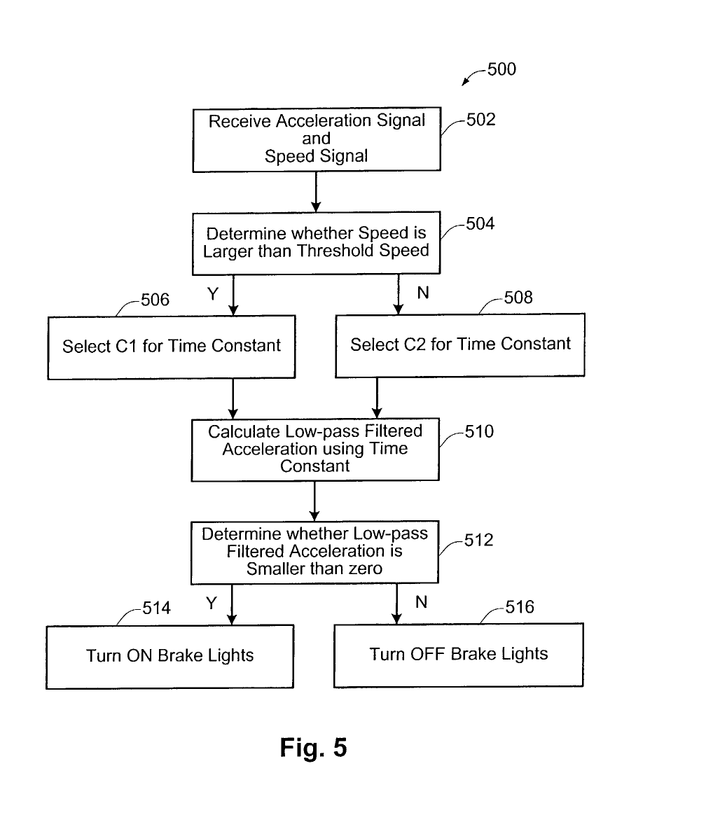

FIG. 4 is a graph showing the acceleration of the vehicle, the low-pass filtered acceleration, and the illumination of the brake light 124 according to one embodiment of the invention shown in FIG. 1. FIG. 5 is a block diagram of a method 500 for controlling illumination of a brake light according to one embodiment of the present invention shown in FIG. 1. According to the embodiment shown in FIG. 1, at 502 in FIG. 5, the LPF 114 receives the signal 105 corresponding to the acceleration 402 of the vehicle, and the signal 109 corresponding to the speed of the vehicle. At 504, the LPF determines whether the speed is larger than the threshold speed Sth in FIG. 2 based on the signal 109. If the LPF 114 determines that the speed is larger than the threshold speed Sth, at 506, the LPF 114 selects the time constant C1 for low-pass filtering. Conversely, if the LPF 114 determines that the speed is smaller than the threshold speed Sth, at 508, the LPF 114 selects the time constant C2 for low-pass filtering.

At 510, the LPF 114 calculates the low-pass filtered acceleration using the time constant at selected 506 or 508 based on the acceleration signal 105. Then, LPF 114 outputs the low-pass filtered signal 115 corresponding to the low-pass filtered acceleration 404 to the logic circuitry 116. At 512, the logic circuitry 116 determines whether the low-pass filtered acceleration 404 is substantially smaller than zero. At 514, if the logic circuitry 116 determines that the low-pass filtered acceleration 404 is substantially smaller than zero, the logic circuitry 116 sets a signal 120 at an “ON” level to turn on the brake light 124 as shown as a brake light state 406 in FIG. 4. At 516, if the logic circuitry 116 determines that the low-pass filtered acceleration 404 is not substantially smaller than zero, the logic circuitry 116 sets the signal 120 at an “OFF” level to turn off the brake light 124 as shown as a brake light state 408 in FIG. 4.

Conventional brake light controllers would turn on the brake lights during time periods 410 and 412. Such time periods are typically caused by intermittent release of the accelerator by the driver. However, in an actual driving condition, such short decelerating periods do not necessarily last for a long time. In other words, those decelerating periods may be followed by accelerating periods 414 and 416. According to conventional brake light controlling schemes, these short decelerating periods 410 and 412 would send a confusing warning message to a following driver. On the other hand, the brake light controller 100 according to the embodiment of the present invention is capable of substantially reducing or eliminating intermittent illumination of a brake light when the vehicle decelerates for a relatively short period of time, such as the periods 410 and 412.

The logic circuitry 116 outputs the signal 120 to the driver 122. The driver 122 drives the brake light 124 based on the signal 120. In some embodiments, the logic circuitry 116 may be provided outside the brake light controller 100. Alternatively, in some embodiments, the function of the logic circuitry 116 is incorporated into the driver 122, and thus, the logic circuitry 116 and the driver 122 are implemented by a single functional block.

In the above-described specific embodiment shown in FIG. 5, the time constant is determined based on the speed signal 109 corresponding to the speed of the vehicle. However, it should be appreciated that, in some embodiments, the brake light controller 100 may use a fixed value of a time constant for the low-pass filtering of the acceleration signal 105, without using the signal 109 from the speed sensor 108. In such a case, the brake light controller 100 may utilize any suitable fixed time constant for use of the low-pass filtering of the acceleration signal 105.

The logic circuitry 118 receives the speed signal 109, and the transmission signal 110, and outputs a signal 126 to the driver 128 for controlling illumination of the backup light 130. The logic circuitry 118 sets the signal 126 at an “ON” level to turn on the backup light 130 when (i) the speed signal 109 represents that the speed of the vehicle is smaller than zero, or (ii) the transmission signal 110 represents that the transmission of the vehicle is in the reverse mode. The logic circuitry 118 sets the signal 126 at an “OFF” level to turn off the backup light 130 when (i) the speed signal 109 represents that the speed of the vehicle is larger than zero, and (ii) the transmission signal 110 does not represent that the transmission of the vehicle is in the reverse mode.

In this specification, the speed of the vehicle is larger than zero when the vehicle is moving forward. Conversely, the speed of the vehicle is smaller than zero when the vehicle is moving backward. However, in some embodiments, the polarity of each signal may be changed as long as each functional block in the brake light controller 100 correctly interprets the meaning of each signal representing a vehicle parameter.

The logic circuitry 118 outputs the signal 126 to the driver 128. The driver 128 drives the backup light 130 based on the signal 126. In some embodiments, the logic circuitry 118 may be provided outside the brake light controller 100. Alternatively, in some embodiments, the function of the logic circuitry 118 is incorporated into the driver 128, and thus, the logic circuitry 118 and the driver 128 are implemented by a single functional block. The brake light controller 100 having the logic circuitry 118 may be advantageous if it is desirable to warn a following driver when the vehicle is actually moving backward due to a steep hill.

In some embodiments, the LPF 114 may be implemented by an integrating functional block. Such an integrating function block receives the acceleration signal 105, and integrates the acceleration signal over an integral interval, thereby performing the low-pass filtering of the acceleration of the vehicle. Further, in some specific embodiments, the LPF 114 may receive the speed signal 109 corresponding to the speed of the vehicle, and modify the integral interval based on the speed signal 109. In other words, the integrating function block described above is an example of the LPF 114 shown in FIG. 1. Thus, the modification of the integral interval corresponds to the modification of the time constant of the LPF 114 as described referring to FIG. 1.

It should be appreciated that some functions included in the brake light controller 100 may be implemented by a single unit or device, such as an integrated circuit, or the like. Further, in some embodiments, at least one functional block in the brake light controller 100 may be omitted, or implemented outside the controller 100. For example, the logic circuitry 118 may be omitted. Alternatively, the logic circuitry 116 may be implemented within the driver 122, which is provided outside the brake light controller 100. In such a case, the brake light controller 100 may include only the LPF 114, or its equivalent functional block including an integrating function block. Conversely, the brake light controller 100 may include external functional blocks such as the A/D converter 103, the converter 107, the drivers 122 and 128, and the like. Further, some of the functional blocks shown in FIG. 1 may be implemented as an integrated functional unit. For example, the LPF 114 and the logic circuitry 116 may be integrated into a single unit. The brake light controller 100 may be incorporated into an engine control unit (“ECU”) of an automobile when it is utilized for controlling the brake lights of the automobile.

In the embodiments described above, the brake light controller 100 receives the digital signals 105, 109, and 110, and process these signals digitally to control illumination of the brake light 124, and the backup light 130. However, the brake light controller 100 may use any type of signal (e.g., a digital signal or an analog signal) as long as each signal represents or corresponds to a vehicle parameters, such as an acceleration of the vehicle, a speed of the vehicle, or the mode of the transmission of the vehicle. The number of the brake light 124, and the backup light 130 may be more than one.

It should be appreciated that the functionality of the embodiments of the present invention can be implemented by any combination of software and/or hardware. The function blocks in the embodiments of the invention may take various forms. It may include one or more general-purpose microprocessors that are selectively configured or reconfigured to implement the functions described herein. Alternatively, it may include one or more specially designed processors or microcontrollers that contain logic and/or circuitry for implementing the functions described herein. Any of the devices serving as one of the functional blocks may be designed as general-purpose microprocessors, microcontrollers (sometimes simply referred to as “controllers”), ASICs (application specific integrated circuits), DSPs (digital signal processors), PLDs (programmable logic devices), FPGAs (field programmable gate arrays), and the like. They may execute instructions under the control of the hardware, firmware, software, reconfigurable hardware, or combinations of these.

The hardware elements described above may be configured (usually temporarily) to act as one or more software modules for performing a part or all of the functions of embodiments of this invention. For example, separate modules may be created from program instructions for performing the functionality of the embodiments according to the present invention as described above. In appropriate cases, a part of the hardware elements in the embodiments can be omitted.

Although specific functional configurations of the brake light controller 100, the associated sensors 104, 108, and 112, the circuitry 116, 118, 122, and 128, and the like have been described in detail above, those specific configurations are not particularly relevant to the present invention. Rather, other various configurations can be used to implement the present invention.

In this specification including the appended claims, the term “or” should be interpreted according to its ordinary meaning, i.e., an inclusive meaning, not an exclusive meaning. Thus, the term “or” describes a list of alternative things in which one may choose one option or any combination of alternative options irrespective of the number of options. For example, an expression “block X may be P, Q, or R” should be interpreted as “block X may be one of P, Q, R, P+Q, P+R, Q+R, and P+Q+R.” This ordinary meaning of the term “or” also applies to the term “either . . . or . . . ” in this specification.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. An apparatus for controlling illumination of a brake light of a vehicle, comprising:
a controller operable to control illumination of the brake light based on a low-pass filtered acceleration of the vehicle.

2. The apparatus of claim 1, wherein the controller is operable to
receive an acceleration signal corresponding to the acceleration of the vehicle; and
perform low-pass filtering of the acceleration.

3. The apparatus of claim 2, further comprising an accelerometer that generates the acceleration signal.

4. The apparatus of claim 2, wherein the controller is further operable to
receive a speed signal corresponding to a speed of the vehicle; and
modify a time constant of the low-pass filtering based on the speed signal.

5. The apparatus of claim 4, wherein the controller is further operable to
set the time constant to a first constant when the speed is larger than a threshold speed, and
set the time constant to a second constant when the speed is smaller than the threshold speed, where
the first constant is substantially smaller than the second constant.

6. The apparatus of claim 2, wherein the controller is operable to integrate the acceleration signal over an integral interval, thereby performing the low-pass filtering of the acceleration.

7. The apparatus of claim 6, wherein the controller turns on the brake light when the integration is substantially smaller than zero, and turns off the brake light when the integration is substantially larger than zero.

8. The apparatus of claim 6, wherein the controller is further operable to
receive a speed signal corresponding to a speed of the vehicle; and
modify the integral interval based on the speed signal.

9. The apparatus of claim 8, wherein the controller is further operable to
set the integral interval to a first interval when the speed is larger than a threshold speed, and
set the integral interval to a second interval when the speed is smaller than the threshold speed, where
the first interval is substantially shorter than the second interval.

10. The apparatus of claim 1, wherein the vehicle has a backup light, and wherein the controller is operable to turn on the backup light based on the speed signal.

11. The apparatus of claim 10, wherein the controller turns on the backup light when the speed signal represents that the vehicle is moving backward.

12. A vehicle comprising the apparatus of claim 1.

13. A controller for controlling illumination of a brake light of a vehicle based on a detected acceleration, the controller being arranged to:
receive an acceleration signal corresponding to the acceleration of the vehicle;
perform low-pass filtering of the acceleration, thereby generating a low-pass filtered signal; and
control the illumination of the brake light based at least on the low-pass filtered signal.

14. The controller of claim 13, wherein the controller is operable to integrate the acceleration signal over an integral interval, thereby performing the low-pass filtering of the acceleration.

15. A method for controlling illumination of a brake light of a vehicle, comprising:
controlling illumination of the brake light based on a low-pass filtered acceleration of the vehicle.

16. The method of claim 15, further comprising:
receiving an acceleration signal corresponding to the acceleration of the vehicle; and
performing low-pass filtering of the acceleration.

17. The method of claim 16, further comprising generating the acceleration signal.

18. The method of claim 16, further comprising:
receiving a speed signal corresponding to a speed of the vehicle; and
modifying a time constant of the low-pass filtering based on the speed signal.

19. The method of claim 18, further comprising:
setting the time constant to a first constant when the speed is larger than a threshold speed, and
setting the time constant to a second constant when the speed is smaller than the threshold speed, where
the first constant is substantially smaller than the second constant.

20. The method of claim 16, further comprising integrating the acceleration signal over an integral interval, thereby performing the low-pass filtering of the acceleration.

21. The method of claim 20, wherein the brake light is turned on when the integration is substantially smaller than zero, and the brake light is turned off when the integration is substantially larger than zero.

22. The method of claim 20, further comprising:
receiving a speed signal corresponding to a speed of the vehicle; and
modifying the integral interval based on the speed signal.

23. The method of claim 22, further comprising:
setting the integral interval to a first interval when the speed is larger than a threshold speed, and
setting the integral interval to a second interval when the speed is smaller than the threshold speed, where
the first interval is substantially shorter than the second interval.

24. The method of claim 15, wherein the vehicle has a backup light, and further comprising turning on the backup light based on the speed signal.

25. The method of claim 24, wherein the backup light is turned on when the speed signal represents that the vehicle is moving backward.
